(19) United States
(12) Patent Application Publication
(10) Pub. No.: US 2007/0113908 A1
(43) Pub. Date: May 24, 2007

(54) VALVE FOR MICROFLUIDIC CHIPS

(75) Inventors: L. James Lee, Columbus, OH (US); Chunmeng Lu, Kearny, NJ (US); Yi-Je Juang, Columbus, OH (US)

Correspondence Address: FAY SHARPE LLP, 1100 SUPERIOR AVENUE, SEVENTH FLOOR, CLEVELAND, OH, 44114, US

(73) Assignee: The Ohio State University and BioLOC, Inc.

(21) Appl. No.: 11/561,149

(22) Filed: Nov. 17, 2006

Related U.S. Application Data
(60) Provisional application No. 60/738,096, filed on Nov. 18, 2005.

(51) Int. Cl. F15C 1/06

(52) U.S. Cl. 137/833

(57) ABSTRACT

A valve is provided for use in a microfluidic platform. The valve is preferably a superhydrophobic fishbone valve that comprises a channel and at least one branch in continuous contact with the channel. The channel has two sidewalls, an inlet, and an outlet. The branch extends outwardly and substantially perpendicularly from each sidewall of the channel. In further embodiments, the number of branches is from one to five. The sidewalls and the walls of the branch(es) preferably have a fluorine coating. The valve retains superhydrophobicity even after exposure to a protein solution.

### CROSS REFERENCE TO RELATED APPLICATIONS

This application claims priority to U.S. Provisional Application Ser. No. 60/738,096, filed Nov. 18, 2005, which is incorporated herein in its entirety by reference.

### BACKGROUND

The present disclosure is directed to a valve which can be used on a microfluidic chip. In particular, the valve is suited for enzyme-linked immunosorbent assays (ELISA) built on a compact disk based microfluidic platform.

Enzyme-Linked Immunosorbent Assay (ELISA) is the most commonly used method of various immunoassays. It has been widely used for detection and quantification of biological agents (mainly proteins and polypeptides) in the biotechnology industry, and is becoming increasingly important in clinical, food safety, and environmental applications. ELISA uses an enzymatic reaction to convert substrates into products having a detectable signal (e.g., fluorescence). Each enzyme in the conjugate can covert hundreds of substrates into products, thereby amplifying the detectable signal and enhancing the sensitivity of the assay. The general principles and procedures used in ELISA are described here with reference to a 96-well microtiter plate:

(a) The first antibody (specific for the antigen to be assayed) is added to an ELISA plate. The first antibody is allowed to adsorb to the solid substrate surface. The excess antibody is removed from the plate after incubation.

(b) The wells are filled with blocking solution. The blocking solution provides proteins, which adsorb to all protein-binding sites and prevent subsequent nonspecific binding of antibody to the plate.

(c) The sample is added. If the sample contains the targeted antigen, it will bond to the adsorbed first antibody to form an antigen-antibody complex. After incubation, the plate is washed.

(d) The conjugate solution is added. The conjugate (the second antibody) is an appropriate enzyme-labeled ligand (usually an antibody), which will bond to the antigen. The conjugate solution is discarded and the plate is washed after incubation.

(e) The developing solution containing the substrate is added, which reacts with the enzyme in the conjugate. Each enzyme is able to convert hundreds of substrate into products to enhance the sensitivity of the assay. The products of the reaction emit fluorescence or change the color of the solution.

This process requires a series of mixing (reaction) and washing steps, which involves in a tedious and laborious protocol. It often takes many hours to two days to perform one assay due to the long incubation times during each step. These long incubation times are mostly attributed to inefficient mass transport from the solution to the surface, whereas the immunoreaction itself is a rapid process. The antibodies and reagents used in ELISA are also expensive. To overcome these drawbacks, industry is miniaturizing and automating ELISA by using 384- or even 1536-well plates and robots to carry out the liquid-handling work. However, the robotic machine is very expensive and not suitable for point-of-use in small diagnostic and testing laboratories. A potential approach is to use microfabricated microfluidic ELISA devices with automatic and reliable (precise) liquid handling functions. Because of their microscale dimensions, the devices can enhance the reaction efficiency, simplify procedures, reduce assay time and sample or reagent consumption, and provide highly portable systems.

Centrifugal fluidic platform technology was first developed in 1969 and the concept since then has been extensively studied. It is advantageous in many analytical situations because of its versatility in handling a wide variety of sample types, ability to gate the flow of liquids (valving), simple rotational motor requirement, ease and economy of fabrication methods, wide range of flow rates attainable, and easy adaptation to existing optical detection methods. Most analytical functions required for a lab-on-a-disc, including metering, dilution, mixing, calibration, and separation have all been demonstrated in the laboratory.

A compact disk (CD) is an attractive platform for multiple parallel assays because of its ability to maintain simultaneous and identical flow rates; perform identical volume additions; and establish identical incubation times, mixing dynamics, and detection in a multitude of parallel assay elements.

The CD-ELISA carries out the ELISA process on a CD microfluidic platform. The concept is to utilize its unique microfluidic function, i.e. flow sequencing, to replace the stepwise procedures carried out in the conventional ELISA process. The CD-ELISA can be a self-contained microdevice that incorporates low-power microfluidic components and high-sensitivity immunomolecules capable of performing parallel and multiple tests with high precision. The CD platform integrates a number of microfluidic functions including pumping, capillary valving, washing, and mixing with required antibodies, reagents, and buffer solution in various reservoirs. By spinning the disc, the centrifugal force overcomes the capillary force and the fluid in each reservoir is pumped sequentially with increasing rotational speed from the center towards the edge of the disc. Control of fluid transfer from one reservoir to another is achieved by manipulating the spin velocity of the disc. By coupling the CD drive with a detection system, samples on the CD can be readily analyzed (e.g. based on absorption or fluorescence). The microfluidic device requires only a minimal sample size (in the sub-microliter range) and its automation can be achieved by modifying a standard CD reader. Compared to conventional ELISA (usually carried out in multiwell plates) and other immunoassays, the new CD-ELISA platform has many advantages, including improved reliability and speed, lower reagent use, and the ability for automation, multiple detections, and high throughput screening.

A conceptual prototype design of a CD-ELISA with 24 sets of ELISA microassays on a 12 cm disk is shown in FIG. 1. The schematic of a single assay is explained in FIG. 2, while an actual assay on a plastic CD is shown in FIG. 3.

The substrate, conjugate, washing, primary antibody, blocking protein, and antigen solution can be preloaded into corresponding reservoirs before the test. The centrifugal and the capillary forces are used to control the flow sequence of different solutions involved in the ELISA process. In brief, the capillary force will prevent the liquid in a small channel from moving to an expanded area, while the centrifugal force may release the fluid from its reservoir when it is larger than the capillary force. The angular frequency at this moment is called the burst frequency, which can be calculated by comparing the centrifugal force and the capillary force. A computer controls the rotational speed of the disk to achieve proper flow sequencing and incubation.

With reference to FIG. 2, the flow sequence is designed in such a way that the antigen solution 3 is released into the measurement 2 site first at a low rotation speed. This action allows the first antibody to bind onto the microchannel surface. The solid surface at the measurement site needs to be modified so that it has a high protein affinity. After incubation, the washing solution 4 is released to wash out the unbounded antibodies into the waste reservoir 1. Then the blocking protein 5, the washing solution 6, the antigen (sample or standard) 7, the washing solution 8, the conjugate solution 9, the washing solution 10, and finally the enzyme substrate 11 are delivered to the measurement site 2, one by one sequentially at increasing rotation speeds.

For prototyping, a five-step flow sequencing CD (see FIG. 4) was used. The first antibody and the bovine serum albumin (BSA) blocking were carried out off-chip. Initially, the first antibody (2.5 μg/ml) was applied to the detection reservoir (reservoir 2). The antibody was allowed to adsorb onto the surface of this reservoir. After incubation, the excess antibody was removed by a washing solution (TWB solution). The blocking solution (TAB solution) was then added to block all protein-binding sites on the surface of the microchip.

After the incubation and washing off of the excess BSA, the antigen/sample, washing, second antibody, and substrate solutions were loaded into their corresponding reservoirs. The CD was mounted onto the motor plate. The rotation speed of the CD was antigen) into reservoir 2 for the binding process of antigen-antibody. According to the literature, several minutes of incubation is sufficient to reach equilibrium of the immunoreaction in a microchannel with a similar dimension of reservoir 2.

After incubation, reservoir 2 was washed with washing solution (from reservoir 8) at a rotation speed of 560 rpm (±30 rpm). Based on previous experience, three (3) times the amount of washing solution is generally sufficient to displace the existing water-based solution in reservoir 2. The washing solution was therefore set at about 3 times that of the volume of reservoir 2 in the CD.

The conjugate solution (second antibody solution in reservoir 9) was released into reservoir 2 at a rotation speed of 790 rpm (±35 rpm) to let the enzyme-labeled secondary antibody bond to the primary antibody. After incubation, reservoir 2 was washed with washing solution (in reservoir 10) at a rotation speed of 1190 rpm (±55 rpm).

The substrate solution (in reservoir 11) was released at a rotation speed of 1280 rpm (±65 rpm) into reservoir 2. Immediately after the release of the substrate, the detection was carried out using an inverted fluorescence microscope (Nikon ECLIPSE TE2000-U). A 100 W mercury light source with a 335/20 nm filter and a dichroic mirror was used as an excitation source. The fluorescence signal was obtained through a dichroic mirror and a 405/40 nm filter. Images were recorded by a 12-bit, high-resolution monochrome digital camera system (CoolSnap HQ). The intensity of the fluorescence was analyzed using the Fryer Metamorph Image Analysis System.

One benefit to using a CD-based microfluidic platform is decreased reaction time. In a 96-well microtiter plate, the specific surface area of 100 μl solution in each well (6.5 mm in diameter and 3 mm in height) is about 944 m²/m³. A microchannel with dimensions of 140 μm×100 μm×2 mm has a specific surface area of 34300 m²/m³, which is about 36 times larger than that of the microtiter plate. This provides more reaction area for the substrate (in unit volume) to react with the enzyme on the solid surface. The diffusion length in the microtiter plate is 3 mm (the height for 100 μl liquid in each well), whereas that of the microchannel is only 50 μm. The characteristic time required for a molecule to diffuse is proportional to the square of the diffusion length. Therefore, the diffusion time of the substrate to the enzyme on the microchannel surface can be much faster than that in the 96-well microtiter plate. The larger surface-to-volume ratio and the shorter diffusion length contribute to the fast enzymatic reaction.

Mixing is a process normally necessary during sample preparation in microfluidic devices for biological analysis and separations. Because of the dimension of micron-sized flow channels, the Reynolds number of fluid flow in the microfluidic systems is extremely small (usually less than 1). The lack of turbulent flow makes the mixing in microdevices a very challenging issue. Molecular diffusion is the main driving force in micro-mixing due to the nature of laminar flow. The characteristic time required for a molecule to diffuse through a distance L is given by the relation

$$t = \frac{{L}^{2}}{2 D} \qquad ( 1 )$$

where D is the diffusivity of the molecule. For example, a moderately sized DNA molecule (D˜10⁻⁶ cm²/s) would require a few hours to diffuse in a 1 mm wide channel. If the width of the channel is reduced to 50 μm, the required diffusion time is several seconds. Therefore, it is generally considered that the optimal dimension of microfluidic channels for BioMEMS application is between 10 μm and 100 μm. Above that, mixing is too slow or additional mixing devices are required. Below that range, the detection will be difficult. For example, a microchannel with a dimension of 50 μm×50 μm×1 mm contains only 2.5 nl sample, which may not have sufficient molecules for detection or for amplification.

The Reynolds number (Re) of a flow determines whether a flow is a laminar flow or a turbulent flow. The Reynolds number can be calculated by the following equation:

$$Re = \frac{ρ v {D}_{h}}{μ} \qquad ( 2 )$$

where the parameters ρ, v, and μ stand for the fluid density, velocity, and viscosity, respectively. Dₕ here is the hydraulic diameter. With Re<2300, the flow can be considered as laminar flow. Because of the tiny size of the microchannel, the flow in the microchannel is almost always considered laminar.

Diffusion, by definition, is the movement of a fluid from an area of higher concentration to an area of lower concentration. Diffusion is a result of the kinetic properties of particles of matter. It can be modeled by the equation:
L=2\sqrt{Dt} (3)
where, L is the distance that a particle travels in time t, and D is the diffusion coefficient of the particle. As seen from the above equation, the moving time for a particle is proportional to the square of the scale. The smaller the scale is, the shorter transport time will be. For example, the diffusion coefficient for a typical antibody is on the order of 10⁻⁶ cm²s⁻¹. Therefore, an antibody molecule will spend more than 10 days to diffuse 1 cm, several minutes to diffuse 100 μm, and less than one sec to diffuse 10 μm.

Major microfluidic components include sample introduction or loading (and in some cases, sample preparation); propulsion of fluids (such as samples to be analyzed, reagents, and wash and calibration fluids) through micron-sized channels; valving; fluid mixing and isolation as desired; small volume sample metering; sample splitting and washing; and temperature control of the fluids. A wide range of microfluidic components such as pumps, valves, mixers, and flow sensors has been demonstrated. The main challenge in making microfluidic ELISA devices is the integration of certain functions at high speed and high throughput.

It is necessary for many microdevices to have microvalves to manipulate fluid flow. Various types of microvalves can be designed and integrated on the microdevices. Based on their requirement of energy to operate, valves can be divided into two categories: passive valves without an energy requirement, and active valves that need energy input to perform actions. One approach is to use a passive capillary-valve that relies on the capillary force to stop the flow in micro-channels. The principle of operation is based on a pressure barrier that develops when the cross-section of the capillary expands abruptly. Capillary valving has the advantage of not requiring any moving parts and external actuation. Recently, this type of valve has attracted a great deal of attention and has a strong appeal for applications in various microfluidic systems.

In the CD microfluidic platform, the centrifugal force provides the pumping pressure. The microchannels are designed radially on a CD-like platform and the fluid is driven by the centrifugal force to flow through the microchannel under rotation of the CD. The pumping force per unit area (P_{c}) due to the centrifugal force is given by:

$$\frac{ⅆ {P}_{C}}{ⅆ r} = ρ {ω}^{2} r \qquad ( 4 )$$

where ρ is the density of the liquid, ω is the angular velocity of the CD platform, and r is the distance of a liquid element from the center of the CD. Integration of Eq. 4 from r=R₁ to r=R₂ gives:

$$Δ {P}_{C} = ρ {ω}^{2} ( {R}_{2} - {R}_{1} ) ( \frac{{R}_{1} + {R}_{2}}{2} ) = ρ {ω}^{2} \cdot Δ R \cdot \overline{R} \qquad ( 5 )$$

where R̅ is equal to

$$\frac{{R}_{1} + {R}_{2}}{2} ,$$

and R₁ and R₂ are the two distances of the liquid elements from the center of the CD.

It is very important for a CD microfluidic platform to deliver the solution from each reservoir in a pre-specified manner. The delivery of solution from a single reservoir allows the measuring reservoir to be filled without releasing solutions in other reservoirs. Capillary burst valves can be incorporated into the microfluidic platform design for this purpose. When the fluid reaches the junction through the microchannel, the capillary force at the end of the microchannel (due to a change in geometry) tends to hold the fluid. The capillary force per unit area (Ps) due to surface tension is given by:

$$Δ {P}_{s} = \frac{C γ sin θ}{A} \qquad ( 6 )$$

where γ is the surface tension of the fluid, θ is the contact angle, A is the cross-section area of the microchannel, and C is the associated contact line length.

The burst frequency is defined as the angular frequency at which ΔPc is greater than or equal to ΔPs. At this rotation speed, the liquid overcomes the pressure generated by the capillary force ΔPₛ and flows through the capillary valve, releasing liquid from the reservoir. The burst frequency, f_{b}, calculated from Eqs. 5 and 6 is given by:

$${f}_{b} = {( \frac{γ sin θ}{{π}^{2} ρ \cdot Δ R \cdot \overline{R} \cdot {d}_{H}} )}^{\frac{1}{2}} \qquad ( 7 )$$

where d_{H} (equal to 4A/C) is the hydrodynamic diameter of the channel connected to the junction. The capillary burst valve is a passive valve that requires no moving parts. It is controlled by the angular speed of rotation, fluid density, surface tension, and geometry and location of the channels and reservoirs.

For pure water or buffer solutions, the capillary valve works well because a proper polymer surface can be chosen to provide a desirable contact angle. However, proteins exist in the solutions used in ELISA. The phenomenon of protein adsorption onto plastic substrates has been widely observed. Due to protein adsorption, the surface of the capillary valve gradually becomes hydrophilic, reducing the contact angle, and the solution wicks through, leading to the failure of the valving function. The issue becomes more serious, i.e. the capillary valve cannot even hold the solutions in the reservoirs, when the blocking solution (protein) is applied on the microchannels to prevent the non-specific binding of proteins.

There is therefore a need for a valve which can maintain its hydrophobicity even in the presence of a protein solution.

### BRIEF DESCRIPTION

Various embodiments of a valve for use in a microfluidic platform, such as a fishbone valve, are disclosed herein. The valve is suitable for maintaining hydrophobicity even in the presence of a protein solution. Methods and processes of making and using such valves are also disclosed.

In one exemplary embodiment, the fishbone valve comprises a channel and at least one branch in continuous contact with the channel. The channel comprises two sidewalls which define an inlet and an outlet. The channel has a length A. The at least one branch extends outwardly from each sidewall and has a width W and a length L.

In other embodiments, the at least one branch extends substantially perpendicularly from each sidewall. In other embodiments, the surfaces of the channel and the branch may be coated by a fluorine plasma coating.

In other embodiments, the ratio L/W is from about 1 to about 2. The width W may be from about 100 μm to about 500 μm.

In other embodiments, the ratio A/L is from about 0.5 to about 1. The length of the channel A may be from about 100 μm to about 500 μm.

In still further embodiments, the channel comprises a plurality of branches. In specific embodiments, the distance between each branch is D and the ratio W/D is about 1. The number of branches may be from 1 to about 5. The distance D may be from about 100 μm to about 500 μm. In specific embodiments, the ratio L/W is 1 for each branch and the distance D between each consecutive pair of branches is constant.

In other embodiments, the sidewalls and the walls of the branch have a water contact angle of at least 90°. In further embodiments, they have a water contact angle of at least 150°.

In other embodiments, the channel has a channel height, the branch has a branch height, and the branch height is greater than the channel height.

In another exemplary embodiment, the fishbone valve comprises a channel and a plurality of branches in continuous contact with the channel. In still another exemplary embodiment, the fishbone valve comprises a channel and four branches in continuous contact with the channel.

These and other non-limiting features of the valve are further disclosed herein.

### BRIEF DESCRIPTION OF THE DRAWINGS

The following is a brief description of the drawings, which are presented for the purposes of illustrating the exemplary embodiments disclosed herein, not for limiting them.

FIG. 1 is a design of a CD-ELISA having 24 sets of ELISA microassays on a compact disk.

FIG. 2 is a schematic of a single ELISA microassay.

FIG. 3 is a picture of an actual ELISA microassay on a plastic CD.

FIG. 4 is a schematic of a single ELISA microassay having five sequencing steps.

FIG. 5 is a diagram showing the location of the fishbone valve between two chambers of an ELISA microassay.

FIG. 6 is a cross-sectional diagram of an exemplary embodiment of a fishbone valve.

FIG. 7 is a diagram of a second exemplary embodiment of a fishbone valve.

FIG. 8 is a diagram of a fishbone valve with surfaces that are blocked by protein.

FIG. 9 is a picture of a fishbone valve with blocking solution flowing through it.

FIG. 10 is a picture of a fishbone valve which is preventing the flow of a protein solution through it.

FIG. 11 is a picture of a conventional capillary valve which does not prevent the flow of a protein solution.

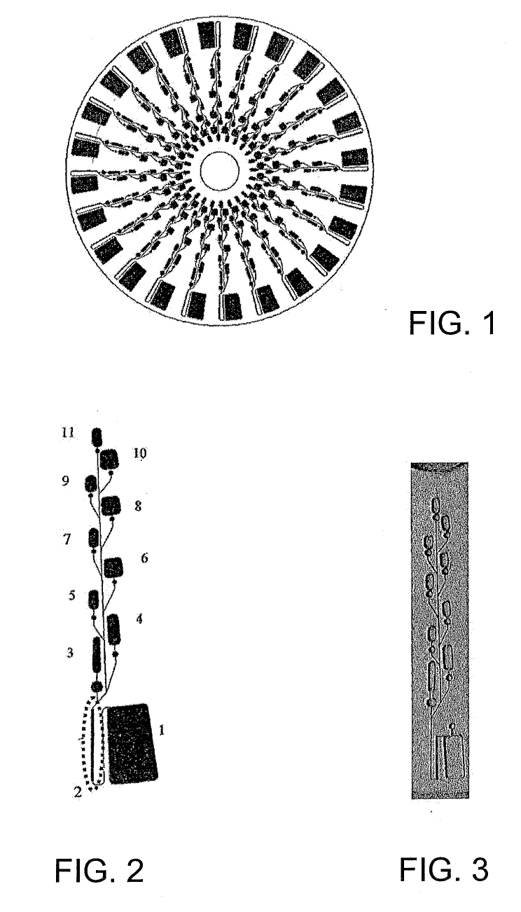

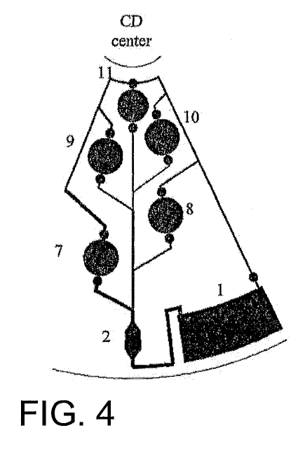

### DETAILED DESCRIPTION

A more complete understanding of the valves and components disclosed herein can be obtained by reference to the accompanying Figures. These Figures are merely schematic representations based on convenience and the ease of demonstrating the present development and are, therefore, not intended to indicate relative size, dimensions, or location of the devices or components thereof and/or to define or limit the scope of the exemplary embodiments. Although specific terms are used in the following description for the sake of clarity, these terms are intended to refer only to the particular structure of the embodiments selected for illustration in the Figures and are not intended to define or limit the scope of the disclosure. In the Figures and the following description below, it is to be understood that like numeric designations refer to components of like function.

Superhydrophobicity is a property that is observed in nature (e.g. lotus leaf) and is caused by the hierarchical roughness of microsized papillae having nanosized protrusions covered with hydrophobic wax. It forms a “composite” surface, i.e. a surface consists of fractions of air and solid. The contact angle can be described by the Cassies' equation:
cos θ*=f cos θ−(1−f) (8)
where θ* is the contact angle of a droplet on the composite surface; θ is the contact angle of a droplet on the flat surface; f is the fraction of solid. The contact angle can be larger than 150° when a water droplet sits on a superhydrophobic surface. One method of making a superhydrophobic surface is to coat the surface with a fluorine plasma. When a water drop is placed on a flat pristine poly(methyl methacrylate) (PMMA) surface, the contact angle is 73°; on a fluorine plasma-treated, flat PMMA surface and a fluorine plasma treated PMMA surface with microstructures, the angles are more than 90° and 150° respectively.

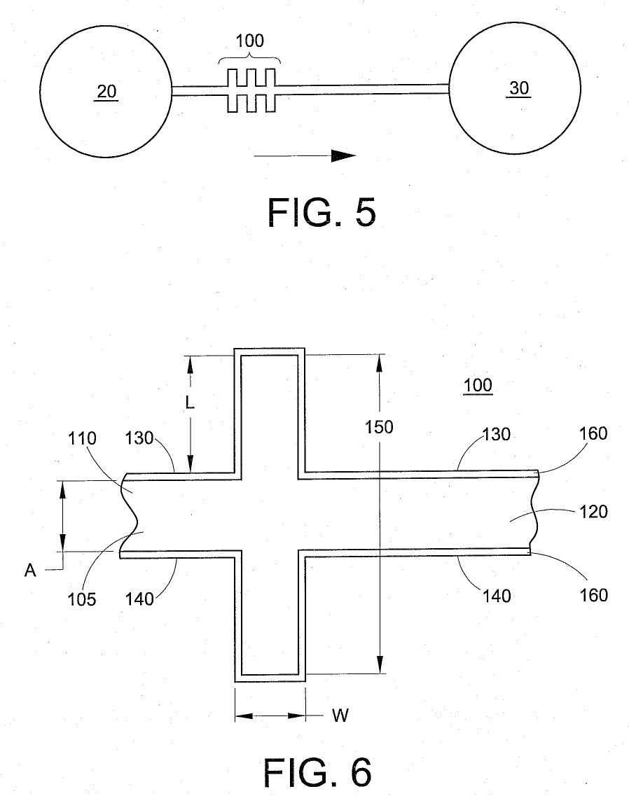

The fishbone valve of the instant disclosure can be used on a microfluidic platform and is especially suitable for use in an ELISA microassay. FIG. 5 is a diagram showing the location of the fishbone valve between two chambers of an ELISA microassay. Here, chamber 20 lies closer to the center of the CD than chamber 30, so that fluid flows in the direction of the arrow, i.e. from chamber 20 to chamber 30. The fishbone valve 100 is located between the two chambers.

FIG. 6 is a cross-sectional diagram of an exemplary embodiment of a fishbone valve. The fishbone valve 100 comprises a channel 105 and at least one branch 150 which is in continuous and/or fluidic contact with the channel 105. The channel 105 comprises two sidewalls 130 and 140 which define an inlet 110 and an outlet 120. The channel has a length A. There is also a floor and a ceiling to the valve and its components. The at least one branch 150 extends outwardly from each sidewall. The at least one branch 150 has a width W and a length L as shown. The length L denotes the distance the branch extends perpendicularly from each sidewall and the width W denotes the distance of the branch that travels parallel with each sidewall. In other words, if the branch 150 does not extend perpendicularly from the sidewall, the branch should be considered the hypotenuse of a right triangle; the width W and length L would be considered the legs of the right triangle.

In specific embodiments, the at least one branch 150 extends substantially perpendicularly from each sidewall. However, it does not need to; capillary force is generated by a sufficiently effective difference between the channel length A and the total length (A+2L) of the at least one branch 150 at each junction where they intersect. Here, the branch 150 is shown as having a rectangular shape. This is generally the best shape for the branch 150 because it is easy to manufacture, provides a clear difference between the channel length A and the total length (A+2L) of the branch 150 along the entire width W of the branch 150, and therefore works more effectively over a wider range of operating conditions. By contrast, in a triangle-shaped branch which tapers out to a final length L, the blocking of capillary action is less effective because the gradient between the channel length A and the total length (A+2L) of the branch 150 is smaller. Nonetheless, branches having shapes other than rectangular are considered within the scope of this disclosure.

The surfaces of the channel 105 and the at least one branch 150 preferably have a fluorine coating 160 upon them. The fluorine coating is usually deposited by a fluorine plasma coating treatment.

In FIG. 6, the fishbone valve 100 is depicted two-dimensionally. The chamber 20, channel 105, and the branch 150 each have a height as well. Generally, the channel 105 and the branch 150 have equal heights. However, in some specific embodiments where a higher flow sequence is desired, the height of the branch may be greater than the height of the channel. In some specific embodiments with a plurality of branches, the height of the channel is less than the height of each branch.

Where the microfluidic platform is a CD, the fishbone valve will be used generally in a radial direction on the CD. In otherwords, the inlet 110 must be closer to the center of the CD than the outlet 120. The fishbone valve should not be used in a circumferential direction, where the inlet 110 and outlet 120 are the same distance away from the center of the CD, because pump forces travel in the wrong direction for the capillary force to regulate fluid flow.

The ratio L/W is the aspect ratio and can be varied from about 1 to about 2. This ratio is important because it influences whether or not the blocking protein solution flows through the fishbone branch(es).

The ratio A/L can be varied from about 0.5 to about 1. This ratio is important because it influences whether or not the blocking protein solution flows through the fishbone branch(es).

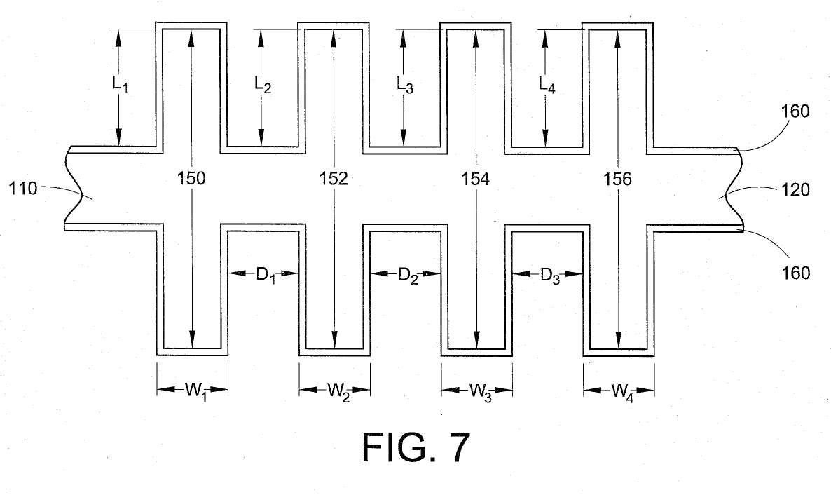

FIG. 7 is a diagram of a second exemplary embodiment of a fishbone valve. In this embodiment, the fishbone valve 100 has a plurality of branches extending outwardly and substantially perpendicularly from each sidewall of the channel. The number of branches can be from 1 to about 5. In this Figure, the fishbone valve has four branches 150, 152, 154, and 156.

Each branch may have a different length and width, as indicated by the variables L₁, L₂, L₃, L₄, W₁, W₂, W₃, and W₄. In addition, there is a distance between each set of branches, as indicated by the variables D₁, D₂, and D₃, each of which may be different as well. However, the variables L and W are generally the same for each branch and the distance D is generally the same between each branch.

In specific embodiments, the length of the channel (i.e. the distance between the two sidewalls), shown as A, can be from about 100 μm to about 500 μm. The width of the branch(es), shown as W, can be from about 100 μm to about 500 μm. The distance between each branch, shown as D, can be from about 100 μm to about 500 μm. These distances A, W, and D, are limited by current manufacturing techniques; shorter distances may be possible in the future.

As noted before, capillary force is generated by a difference between the channel length A and the total length of each branch at the junction where they intersect. In the fishbone valve, each branch has a length sufficiently effective to prevent fluid flow by capillary force. The length of each branch, shown as L, may also vary according to W and A. Where there are multiple branches, each of the variables W, D, and L may vary independently.

One additional advantage of the fishbone valve design having a plurality of branches is that each additional branch provides redundancy if a branch closer to the inlet fails. This redundancy especially prolongs the holding time of the reagent/washing solutions in the reservoirs during the ELISA process when a fishbone valve is used to control the flow of these reservoirs.

The fluorine coating 160 may be deposited on the surfaces of the fishbone valve by any method known in the art. In particular, the valve can be surface treated with fluorine plasma. After this fluorine treatment, the sidewalls 130 and 140, as well as the walls of the branch(es), will have a water contact angle of at least 90°. In further embodiments, the sidewalls, as well as the walls of the branch(es), will have a water contact angle of at least 150°.

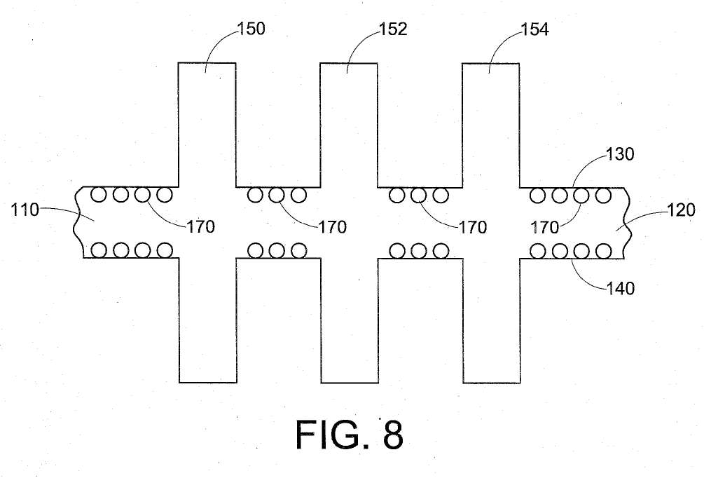

The valving function of the fishbone valve remains even after protein blocking of the valve. This is because the blocking/protein solution only wets (or blocks) a portion of the valve surface as shown schematically in FIG. 8. In this Figure, the fluorine coating is not shown even though it is present. Due to the micrometer size of the fishbone valve, any fluids exhibit laminar flow, so the blocking solution only contacts the sidewalls 130 and 140 of the channel; it does not contact the walls of the branches 150, 152, and 154. Therefore, protein 170 is only adsorbed on the sidewalls 130 and 140. The surfaces of the branches 150, 152, and 154 remain superhydrophobic rather than becoming hydrophilic due to protein adsorption.

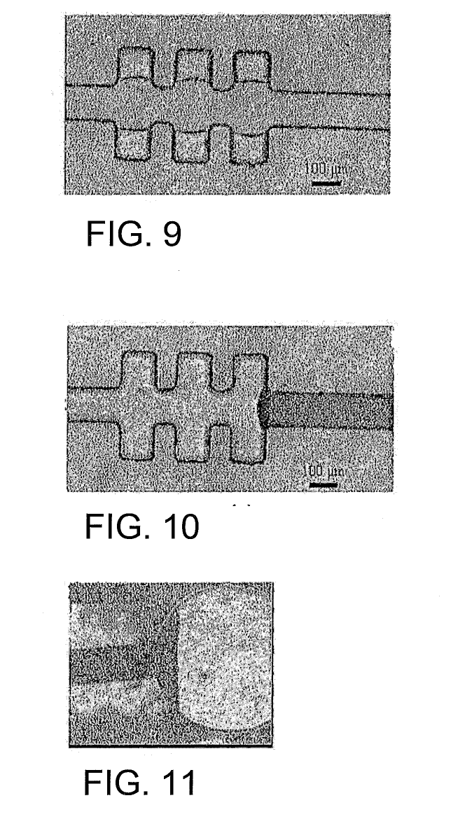

FIG. 9 is an experimental photo showing the blocking/protein solution being injected through the channel and only contacting the sidewalls of the channel, not the surfaces of the branches. The blocking/protein solution is visible as a darker fluid flowing through the outline of the valve.

FIG. 10 is an experimental photo showing the function of the fishbone valve after a blocking/protein solution has already gone through the valve. An aqueous protein solution, coming from the right-hand side of the photo, is then flowed through the channel by means of capillary force. The fishbone valve is able to stop the flow, as indicated by the darker color of the solution being held at the right so it does not flow through the valve. Note the meniscus formed by surface tension at the fishbone valve inlet.

FIG. 11 is an experimental photo of a conventional capillary valve after a blocking/protein solution has already gone through the valve. An aqueous protein solution, coming from the left-hand side of the photo, is then flowed through the channel by means of capillary force. This conventional valve was unable to stop the flow, as seen by infiltration of the darker color of the solution into the circular reservoir. Protein adsorption rendered the valve hydrophilic so the solution could wick through.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A valve for use in a microfluidic platform, comprising:
a channel comprising two sidewalls, defining an inlet and an outlet, and having a channel length A; and
at least one branch in continuous contact with the channel, wherein the branch extends outwardly from each sidewall and has a width W and a length L.

2. The valve of claim 1, wherein the at least one branch extends substantially perpendicularly from each sidewall.

3. The valve of claim 1, wherein the surfaces of the channel and the at least one groove have a fluorine coating.

4. The valve of claim 1, wherein the ratio L/W is from about 1 to about 2.

5. The valve of claim 1, wherein the ratio A/L is from about 0.5 to about 1.

6. The valve of claim 1, wherein the channel has a plurality of branches extending outwardly from each sidewall.

7. The valve of claim 6, having a distance between each branch D, wherein D is from about 100 μm to about 500 μm.

8. The valve of claim 6, wherein the number of branches is from 1 to about 5.

9. The valve of claim 6, wherein the length and width of each branch is equal and the distance between each consecutive pair of branches is constant.

10. The valve of claim 9, wherein the ratio W/D is about 1.

11. The valve of claim 1, wherein the width of the channel A is from about 100 μm to about 500 μm.

12. The valve of claim 1, wherein the width of the branch W is from about 100 μm to about 500 μm.

13. The valve of claim 1, wherein the sidewalls and the walls of the branch have a water contact angle of at least 90°.

14. The valve of claim 1, wherein the channel has a channel height, the branch has a branch height, and the branch height is greater than the channel height.

15. A superhydrophobic valve for use in a microfluidic platform, comprising:
a channel comprising two sidewalls, defining an inlet and an outlet, and having a length A; and
a plurality of branches in continuous contact with the channel, each branch extending outwardly and substantially perpendicularly from each sidewall and having a width W and a length L;
wherein the surfaces of the channel and the plurality of branches have a fluorine coating.

16. The valve of claim 15, wherein the length and width of each branch is equal and the distance between each consecutive pair of branches is equal.

17. The valve of claim 15, wherein the width of the channel A is from about 100 μm to about 500 μm.

18. The valve of claim 15, wherein the channel has a channel height, each branch has a branch height, and the channel height is less than the height of each branch.

19. The valve of claim 15, wherein the sidewalls and the walls of each branch have a water contact angle of at least 150°.

20. The valve of claim 15, wherein each branch has the same width W and length L, and each consecutive pair of branches is separated by a constant distance D.

21. A superhydrophobic fishbone valve for use in a microfluidic platform, comprising:
a channel comprising two sidewalls, defining an inlet and an outlet, and having a length A; and
four branches in continuous contact with the channel, each branch extending outwardly and substantially perpendicularly from each sidewall and having a width W and a length L;
wherein the surfaces of the channel and the four branches have a fluorine coating; and
each branch has the same width W and length L.
